(19) United States
(12) Patent Application Publication
(10) Pub. No.: US 2010/0230555 A1
(43) Pub. Date: Sep. 16, 2010

(54) Universal holding device

(76) Inventor: Alfred R. Edinger, Toms River, NJ (US)

Correspondence Address: ALFRED R. EDINGER, 14 SUMNER AVE., TOMS RIVER, NJ, 08755, US

(21) Appl. No.: 12/381,450

(22) Filed: Mar. 12, 2009

(51) Int. Cl. A47D 15/00; A47B 96/06; E05D 5/10; B25G 1/00

(52) U.S. Cl. 248/104; 248/309.1; 16/386; 16/422

(57) ABSTRACT

These three embodiment(s) possess some/all of basic elements/components/characteristics. They disclose either Open-Circle or U-Shape design(s). Universal Holding Device (Adjustable) (FIG. 1), main body has a removable Support Bracket (22), on right side of lower limb. From here move left, than up to Thumb Screw/Hand Knob (24). Continue up to upper limb, turn right to Hinge (28). It has two flat surfaces held together w/Bolt (28.a.), Nut (28.b.) and Quick Release Pin (28.c.). Next is Ratchet (30.) (i.e. Rotates 240°) with Quick Release Handle (30.a.). Next is Adjustable Arm (32.). Next is Junction Bracket (34.) (i.e. w/Thumb Screws/Hand Knobs (34.a. & 34.b.). Turn right onto Adjustable Rod (36.). Next is Attachment Bracket (38.) w/Quick Release Pin (38.a.). All attachments are permanently attached at factory to Quick Attachment Rod (40.). They are inserted into Attachment Bracket (38.), and secured w/Quick Release Pin (38.a.). Embodiments, FIG. 16.,/18., adds a different dimension.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field

This application relates to Universal Holding Device for household and industry use holding light, medium, and heavy, weight items.

2. Prior Art—Advantages

There are no Universal/General Holding Devices. There are only specialized holding devices for holding specific items. There's no Baby Bottle Holders presently in the market place. The ones that are patented appear antiquated/cumbersome/poorly designed for today's environment. The entire baby bottle holders listed below appear to be designed to accommodate only a small few of the baby bottles in the market place.

Several types of holding devices are listed below—for example, Baby Bottle Holders, U.S. Pat. No. 6,598,838 B2, (2003); D462,775 S (2002); Book Holder; U.S. Pat. No. 7,152,840,B2, (2006); Food & Drink Holder, U.S. Pat. No. 7,360,747; US D557,495 S, Ornamental Portable Holding Device, (2007); and US D560,088, Ornamental Equipment Holding Device (2008).

This device will fill the void for Universal Holding Devices and Baby Bottle Holders, listed here-in and more. Prior Art didn't have the components and material that my invention proposes. With today's modern technology this multi-purpose device can be easily adapted to perform a variety task and be marketed for a reasonable priced.

### SUMMARY OF THE INVENTION

In accordance with one embodiment, the Universal Holding Device is a multi-purpose device that will provide countless hours of assistance in household and industry. It is easy to install competently, and operate safely. It has ability to hold a variety of light, medium and heavy weight Serviceable Devices. It can be manufactured with a variety of materials (e.g. plastics, aluminum & steel). It can be attached temporally or permanently using several different devices to a variety of different items/material. It has a Quick Release Pin installed in Attachment Bracket, for quick/easy attachment/detachment of Serviceable Devices. Another Quick Release Pin is installed in two positions Hinge. With Pin pulled, Hinge with attached Serviceable Devices can be swung from in-work to out-work position upon completion of task/emergency. Junction Bracket moves left/right on Adjustable Arm. Adjustable Rod moves in/out on Junction Bracket. It has Ratchet(s) with Quick Release Safety Knob Handles that allow for angle adjustment of Serviceable Devices.

It can assist mothers with small children by holding different items. That is: Baby Bottles or Sippie Cups, for a child in a Baby Stroller, Car Seat/Carrier, or High-Chair etc. It has a variety of Serviceable Device: Tray to hold books, music sheets, toys, food, drinks for infants /sick/injured/elderly persons; Computer Table for Laptop/Note Book; Bracket for holding LED magnetic base work lights; Single and Multi Hook-Eye, for holding toys and tools. Potential/capability of holding numerous unmentioned items for: workers, sportsmen, hobbyist, and housewives.

### DRAWINGS—FIGURES

FIG. 1. is an overall side view of complete Universal Holding Device, i.e. Adjustable, first embodiment. This view is first embodiment of my invention. It shows all the parts in sequence, and has an open circle appearance. All of remaining FIG. 2., through 17., are detail drawings of parts and attachments. They expand overall scope of FIG. 1., and show how all parts are interconnected.

FIG. 2. shows five views. Top left overall view is, Holding Device Body, Removable, Thumb Screw/Hand Knob(s), Removable and Fixed, and Support Bracket. Detail view of Support Bracket, Removable, i.e. top right. Top right projected view is Support Bracket. Two lower right views, i.e. top and bottom views of Thumb Screw/Hand Knob(s), Removable.

FIG. 3. shows two detail views, i.e. side and top, of Hinge with Quick Release Pin.

FIG. 4. shows five views. There is a detail side view of complete Ratchet with Quick Release Safety Knob Handle showing all major parts. There are also four exploding views of working pieces, i.e. Internal, Out-side, Projected and Inside Views, and Junction Bracket.

FIG. 5. is a side detail view of Adjustable Arm, integrated with adjoining parts, i.e. Ratchet with Quick Release Safety Knob Handle.

FIG. 6. shows Junction Bracket, Adjustable Rod and Safety Knob. There are five views i.e. two top views, two projected views and one front view, and how all parts interconnect.

FIG. 7. shows two front detail views. Right view is Attachment Bracket with Quick Release Pin and Baby Bottle Holder. Left view is Ratchet with Quick Release Safety Knob Handle, Attachment Bracket with Quick Release Pin and interconnecting parts.

### SERVICEABLE DEVICES, FIG. 8-17

FIG. 8. shows two projected views. Top right view is Baby Bottle Holder, Clam Shell. Lower left view is Baby Bottle & Sippie Cup Holder, Open Shell, Adjustable.

FIG. 9. shows two views. Left view is detail cut away side installed view of Slug for Car Seat/Baby Carrier. Right view is outside installed view of Slug for Car Seat/Baby Carrier, and interconnecting parts.

FIG. 10. is a top view of Tray, Deep or Shallow.

FIG. 11 shows three views. One projected top and two exploded views of Computer Table, i.e. Lap Top/Note Book, and fixtures.

FIG. 12. is a side view of Attachment Rod Base.

FIG. 13. shows two views of Hook-Eye Device(s). There is One Single Hook-Eye Device, and one Multiple Hook-Eye Device.

FIG. 14. shows three views, cut-away, end, and projected, of Mounting Bracket with Thumb Screw/Hand Knob and fixtures.

FIG. 15. shows two views, top projected and cut-away side, of Rotating Mounting Bracket

FIG. 16. shows a projected view of Temporary Mounting Bracket.

FIG. 17. shows a projected view of Wall Mounting Bracket.

### SECOND EMBODIMENT

FIG. 18. is a overall view of Universal Holding Device, i.e. Fixed, and its associated parts. It shows parts in sequence, and has an open circle appearance. This is second embodiment of my invention.

FIG. 19. shows a detail cut-away side and outside view of Slug with Thumb Screw(s)/Hand Knob(s).

### THIRD EMBODIMENT

FIG. 20. shows three views. It has one overall view of Universal Holding Device Body, Change. Two lower detail views are Ratchet with and without Quick Release Safety Knob. It shows parts in sequence, and has a U-Shape appearance. This is third embodiment of my invention.

### DRAWING FIGURES—REFRENCE NUMBERS WORKSHEET

20. Holding Device Body (Removable), 20.a. Holding Device Body w/Holes/Indents/Notches (Movable)
22. Support Bracket (Removable)
24. Thumb Screws/Hand Knob (Removable), 24.a. Thumb Screw/Hand Knob Pressure Plate, (Removable)
26. Thumb Screws/Hand Knob
28. Hinge, 28.a. Bolt, 28.b. Nut, 28.c. Quick Release Pin, 28.d. Quick (Open Shell, Adjustable) Release Pin Hole/Safety Hole (i.e. two holes on each piece, one on each piece is at a different location), & 28.e., Support(s)
30. Ratchet w/Quick Release Safety Knob Handle, 30.a. Ratchet with Teeth, 30.b. Inside Teeth/Outside Cam, 30.c. Inside Cam/Outside Quick Release Handle (w or w/o Safety Knob), 30.d. Bolt, 30.e. Nut, 30.f. Cap
32. Adjustable Arm, with 32.a. Holes/Indents/Notches
34. Junction Bracket, 34.a., b. Thumb Screws/Hand Knobs
36. Adjustable Rod, 36.a. w/Holes/Indents/Notches
38. Attachment Bracket, 38.a. Quick Release Pin
40. Quick Attachment Rod, 40.a. Quick Release Pin Hole
42. Baby Bottle Holder (Clam Shell)
42.a. Hinge
42.b. Velcro
44. Baby Bottle Holder/Sippie Cup Holder (Open Shell, Adjustable)
46. Slug, 46.a. Slug Tongue, 46.b. Car Seat/Baby Carrier
48. Tray, 40. w/Quick Attachment Rod, 40.a. Quick Release Pin Hole
50. Attachment Base with metal base, designed for devices with a magnetic base
52. Mounting Bracket, 52.a. Fastener, 52.b. Thumb Screw/Hand Knob, 52.c. Fastener Holes
54. Rotating Mounting Bracket, 54.b. ThumbScrew/Hand Knob, 54.c. Attachment Fixture, 54.d. Ball and Spring Plunger/Hand Retractable Spring Plunger/Pull Ring Spring Plunger, 54.e.
56. Temporary Mounting Bracket and 56.a. Thumb Screw/Hand Knob
58. Computer Table, (Lap Top/Note Book) 58.a. L-Bracket, 58.b. Thumb Screw/Hand Knob, 58.c. U-Bracket
60. Single Hook—Eye, 60.a. Single Hook, 60.b. Single Eye, 40. Quick Attachment Rod, 40.a. Quick Release Pin Hole
62. Multi Hook—Eye, 62.a. Hook, 62.b. Eye, 62.c. Insert Cup, 40. Quick Attachment Rod, 40.a. Quick Release Pin Hole
70. Holding Device Body (Fixed), 70.a. Holding Device Body (Movable)
72. Thumb Screw/Hand Knob
74. Adjustable Rod, with 74.a. Holes/Indents/Notches in base Holes/Indents/Notches, with Fixed Attachment(s), 42 & 44, i.e. Baby Bottle(s)/Sippie Cup Holders
76. Slug with 76.a. Thumb Screw/Hand Knob
80. Holding Device Body (Change), 80.a. Holding Device Body (Movable)
82. Fixed Arm, with 82.a. Attachment Bracket and, 82.b. Quick Release Pin
90. Safety Caps (i.e. for Adjustable Arm 32. and Adjustable Rod 36.) and 90.a. Thumb Screw/Hand Knob
92. Wall Mounting Bracket

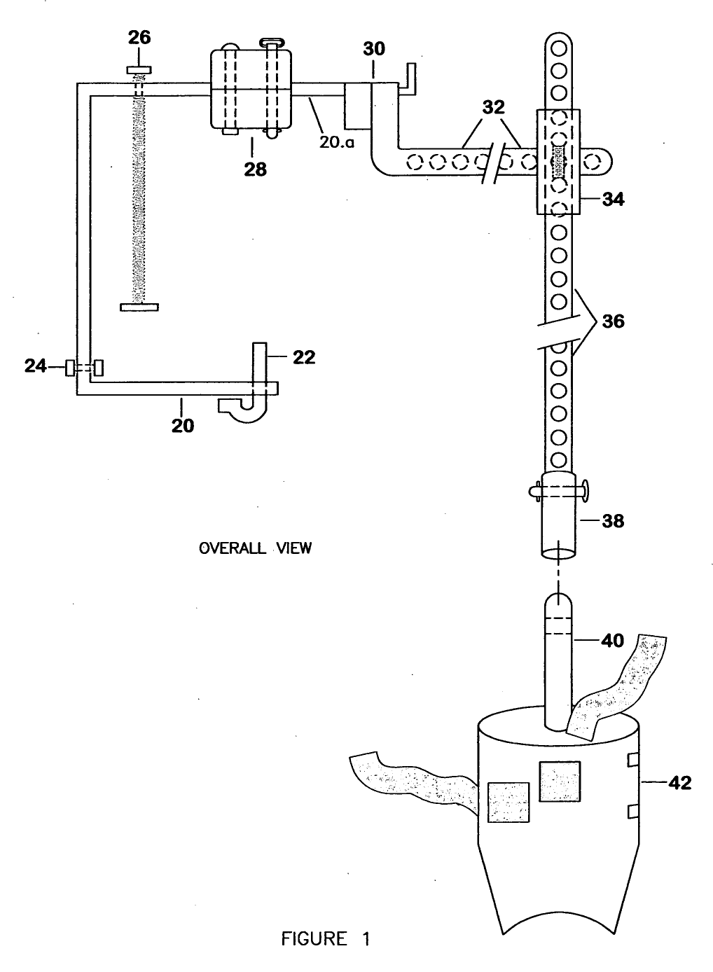

### DETAILED DESCRIPTION—FIRST EMBODIMENT: FIG. 1-7

FIG. 1., shows an overall view of Universal Holding Device Body, Adjustable, and has appearance of an open circle. All remaining Figures, 2 through 7 are detail drawings/upgrades that expands overall scope of FIG. 1.

First item starts on right side of lower/main limb, at Support Bracket, Removable, 22. Move to left on lower, main limb/Holding Device Body, Adjustable, 20., to vertical upright. Turn up on vertical Holding Device Body, Adjustable, 20., to Thumb Screws/Hand Knobs, Removable, 24. Continue up vertical, main limb to top, horizontal limb, turn right, stop at Thumb Screw/Hand Knob 26. Move right on main limb/Holding Device Body 20., to Hinge 28. Hinge 28., is integrated/attached on left side to main limb/Holding Device Body, Adjustable, 20. Hinge 28., is integrated/attached on right side by Holding Device Body, Movable, 20.a. Move right on Holding Device Body, Movable, 20., to Ratchet with Quick Release Safety Knob Handle 30. Ratchet with Quick Release Safety Knob Handle 30., is integrated/attached on left to Holding Device Body, Movable. 20.a. Ratchet with Quick Release Safety Knob Handle 30., is integrated/attached on right with Adjustable Arrn 32. Move right on Adjustable Arm 32., to Junction Bracket 34. At Junction Bracket 34., we make another right turn onto Adjustable Rod 36. At the lower end of Adjustable Rod 36., is Attachment Bracket 38. Adjustable Rod 36 is integrated/attached to Attachment Bracket 38. Next is projection lines from Attachment Bracket 38., to Quick Attachment Rod 40. Integrated/attached to Quick Attachment Rod 40., is Baby Bottle Holder 42.

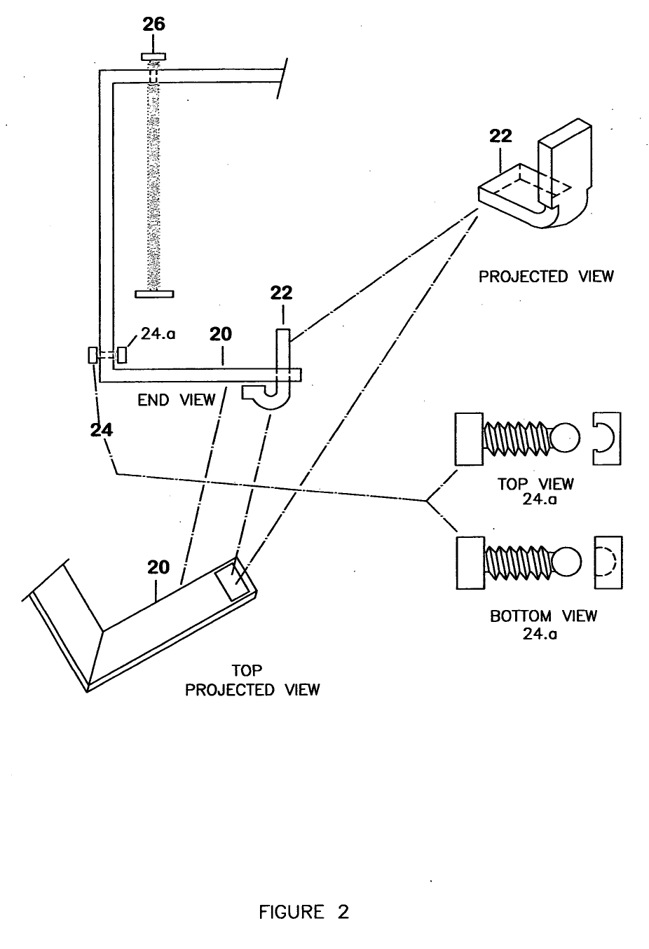

### DETAIL FIGS. 2-7

FIG. 2., is a large detail side u-shape view of main support/Holding Device Body, Adjustable, 20. Starting at lower right side of lower main limb/Holding Device Body, Adjustable, 20., is Support Bracket, Removable, 22. Moving left to end and up slightly on Holding Device Body, Adjustable, 20., is Thumb Screw/Hand Knob, Removable, 24. Moving up main limb to top, turn right to Thumb Screw/Hand Knob 26. From Holding Device Body, Adjustable, 20., and said parts there are projection lines to four exploded views. At top right is a exploded/projected view of Support Bracket, Removable, 22. Below right are two exploded views of Thumb Screw/Hand Knob, Removable, 24. On lower left side is a top projected view of Holding Device Body, Adjustable, 20. Projected view of Support Bracket 22., shows two shoulders on lower vertical part. This narrow width continues to end of horizontal part. Below right are exploded top and bottom views of Thumb Screw/Hand Knob, Removable, 24., and Thumb Screw/Hand Knob Pressure Plate, Removable, 24.a. Below left is top view of bottom limb, Holding Device Body, Adjustable, 20., showing opening for Support Bracket 22.

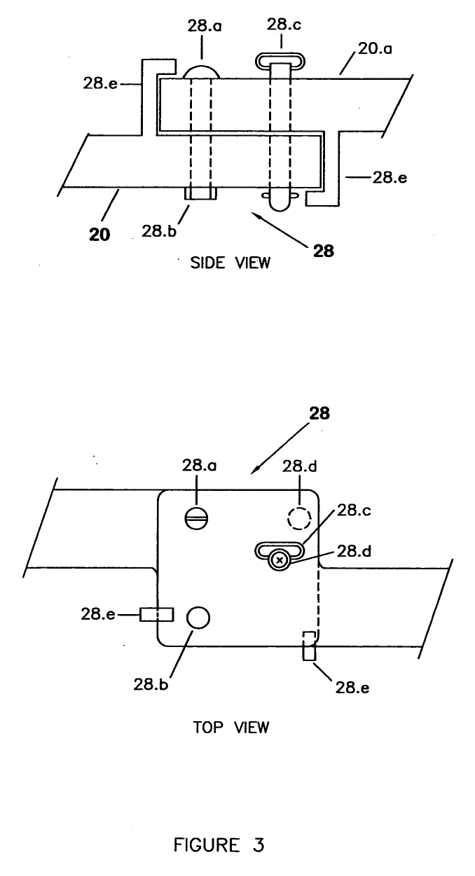

FIG. 3., shows a detail side and top views of Hinge 28. Hinge 28., consists of two flat surfaces. Lower left piece of side view shows Hinge integrated on left-side with Holding Device Body, Adjustable, 20. Top right piece of side view shows Hinge integrated on right-side with Holding Device Body, Movable, 20.a. Hinge 28., with it's two flat surfaces have two Support(s) 28.e., one on each half. These two flat surfaces are held together with a Bolt 28.a., Nut 28.b., and Quick Release Pin 28.c. Bottom and top parts of Hinge 28., each have two holes. One hole on each piece is occupied with Quick Release Pin 28.c. Other two holes are vacant. There is Loop/Handle at the top of Quick Release Pin 28.c. On the bottom of Quick Release Pin 28.c., are two protruding ball bearings.

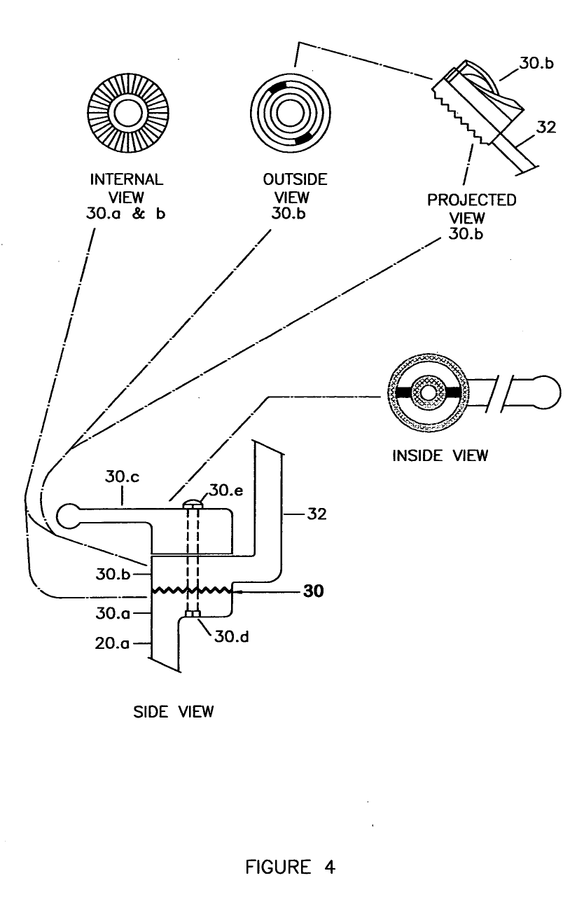

FIG. 4., shows five views. One overall side view, and four other views. At lower left is overall side view of Ratchet with Quick Release Safety Knob Handle 30. This device is integrated on one side with Holding Device Body, Movable, 20.a. It is integrated on opposite side with Adjustable Arm 32. Overall side view shows all the major parts. Starting at Holding Device Body 20.a., is integrated with Ratchet with Teeth 30.a. Next is Ratchet with Teeth on one side and Cam 30.b., on other side. Ratchet and Teeth 30.b., is integrated with Adjustable Arm 32. Next is Quick Release Safety Knob Handle, with Cam 30.c. These parts are held together with Bolt 30.d., and Nut 30.e. On upper left are three views: internal, outside and projected. First is internal view showing Ratchet Teeth 30.a.& b. Second view is outside of Ratchet Cam 30.b. Third is projected view of Ratchet with Teeth and Cam 30.b. On right side, middle of page is, inside view of Quick Release Safety Knob Handle 30.c.

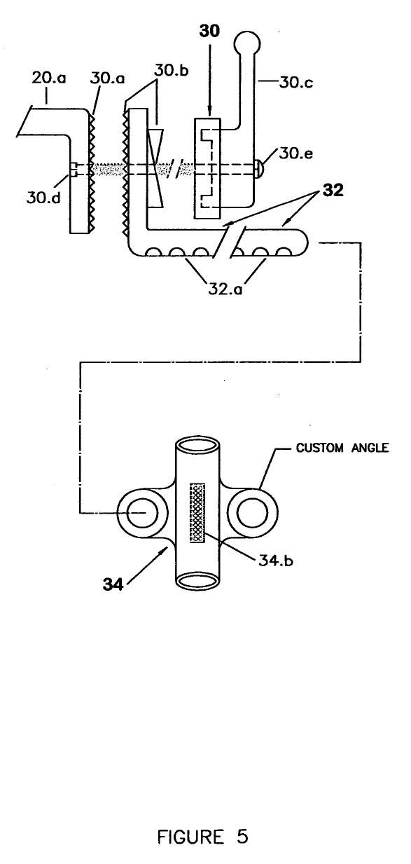

FIG. 5., shows overall detail side view of Adjustable Arm 32., integrated with Ratchet with Quick Release Safety Knob Handle 30. On lower right side is Adjustable Arm 32., integrated with Ratchet with Teeth and Cam 30.b. Adjustable Arm 32., with Holes/Indentations/Notches 32.a., is available in different lengths. FIG. 5., gives another internal prospective view of Ratchet with Quick Release Safety Knob Handle 30. Here is Holding Device Body, Movable, 20.a., integrated with Ratchet with Teeth 30.a. Next is Ratchet with Teeth integrated with Cam 30.b. Next is Quick Release Safety Knob Handle 30.c. These are secured with Bolt 30.d. and Nut 30.e. At bottom center of page is Junction Bracket 34.

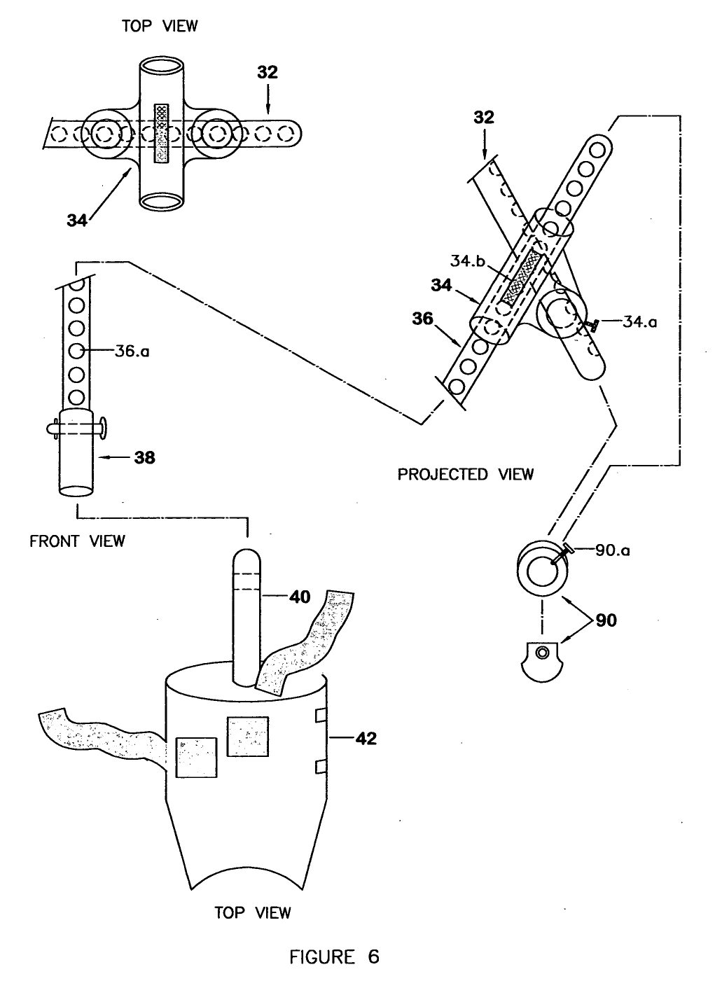

FIG. 6., depicts five views. Starting at top center of page is a view of Junction Bracket 34. Junction Bracket 34., has appearances of two tubes, positioned perpendicular one on top of another. Here, Adjustable Arm 32., with Holes/Indentations/Notches, is supporting Junction Bracket 34. On the left side is a front view of Adjustable Rod 36., with Holes/Indentations/Notches. On right side is a projected view of Junction Bracket 34. It shows all three parts fitting together. On bottom side of Junction Bracket 34., is Thumb Screw/Hand Knob 34.b. On top side of Junction Bracket 34., is Thumb Screw/Hand Knob 34.a. Next is a top and projected views of Safety Cap 90., with Thumb Screw/Knurled Head Slotted Screw 90.a.

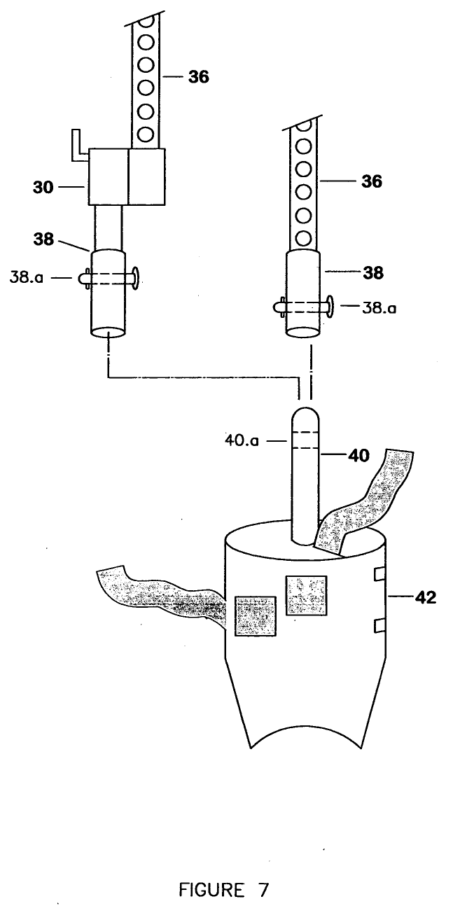

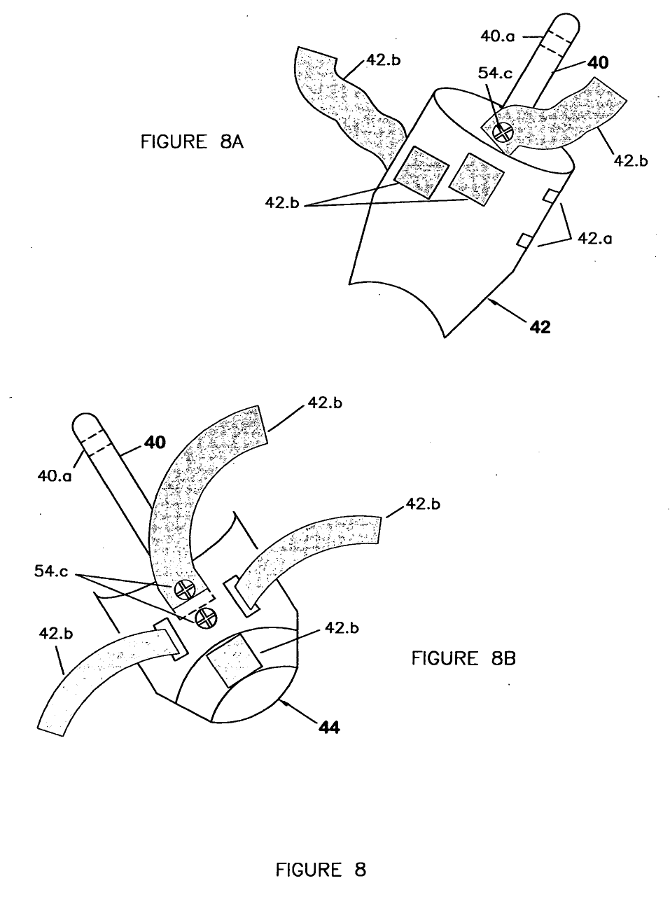

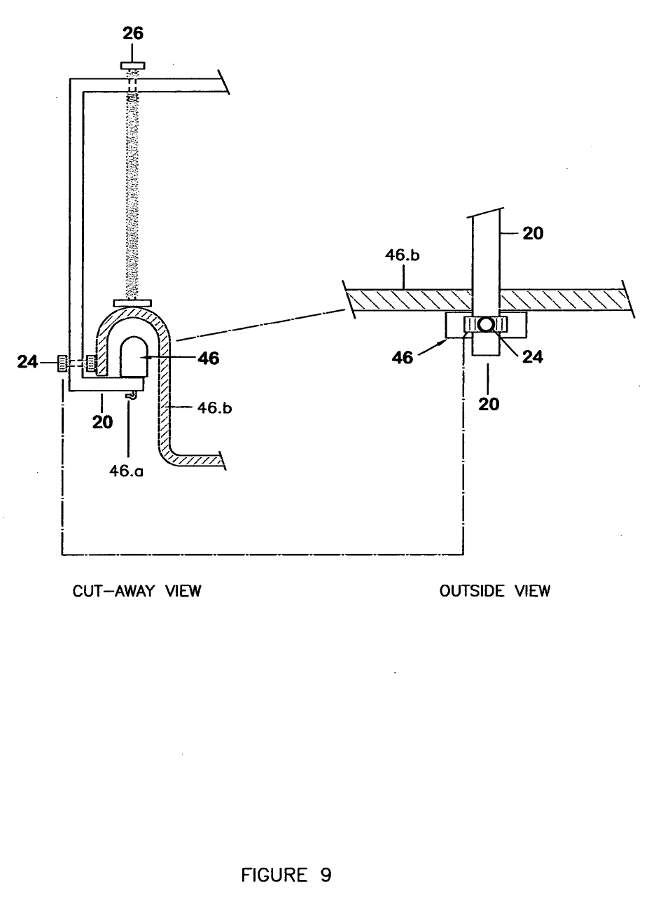

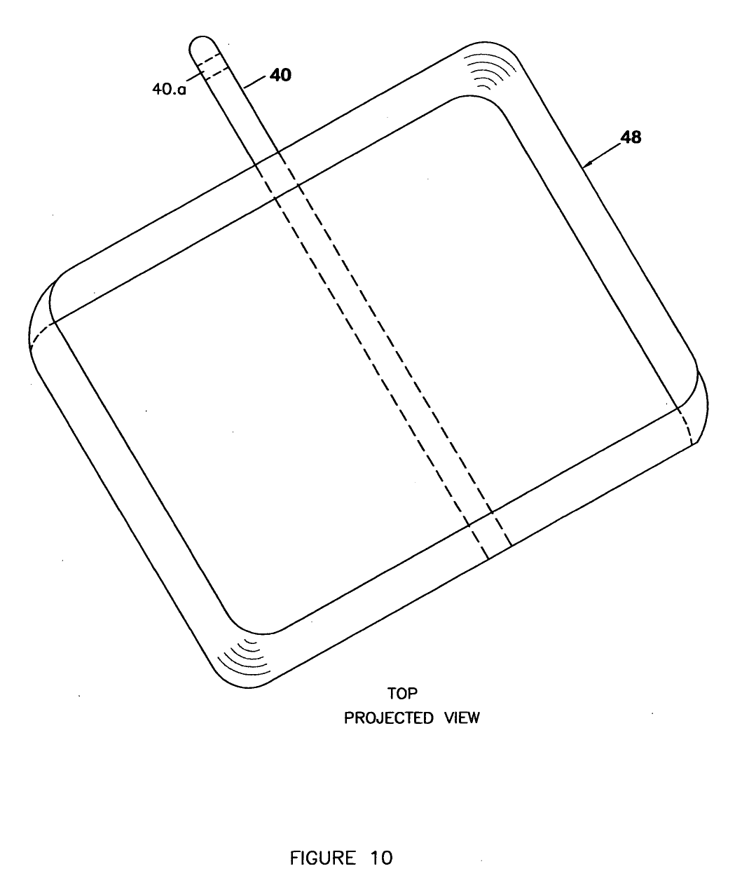

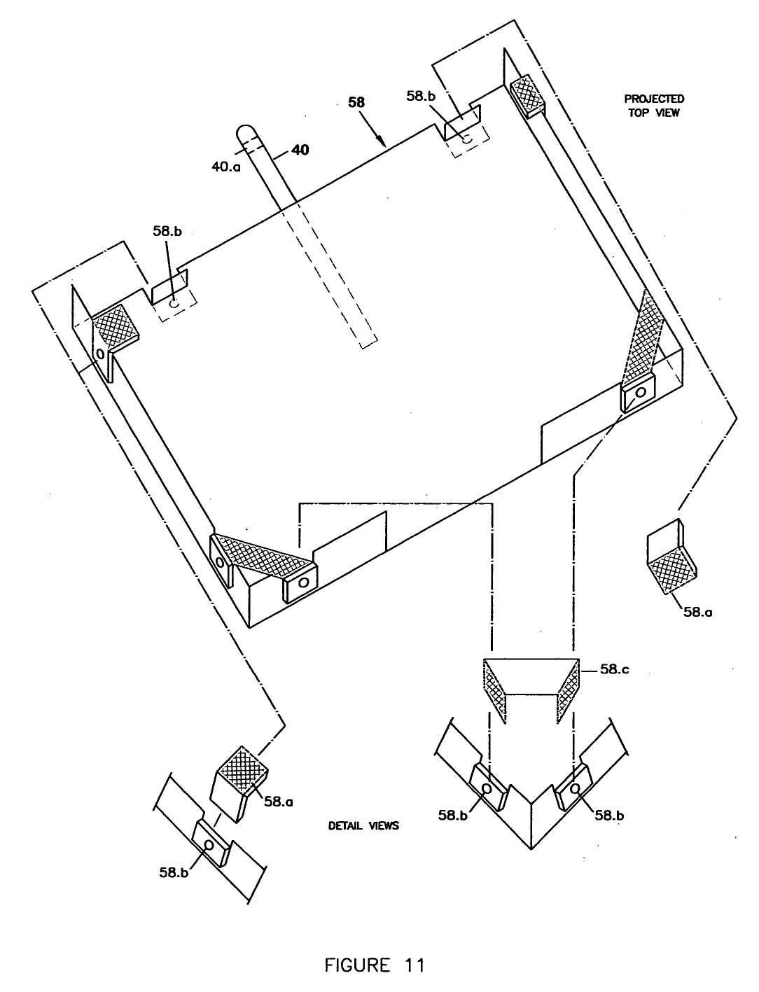

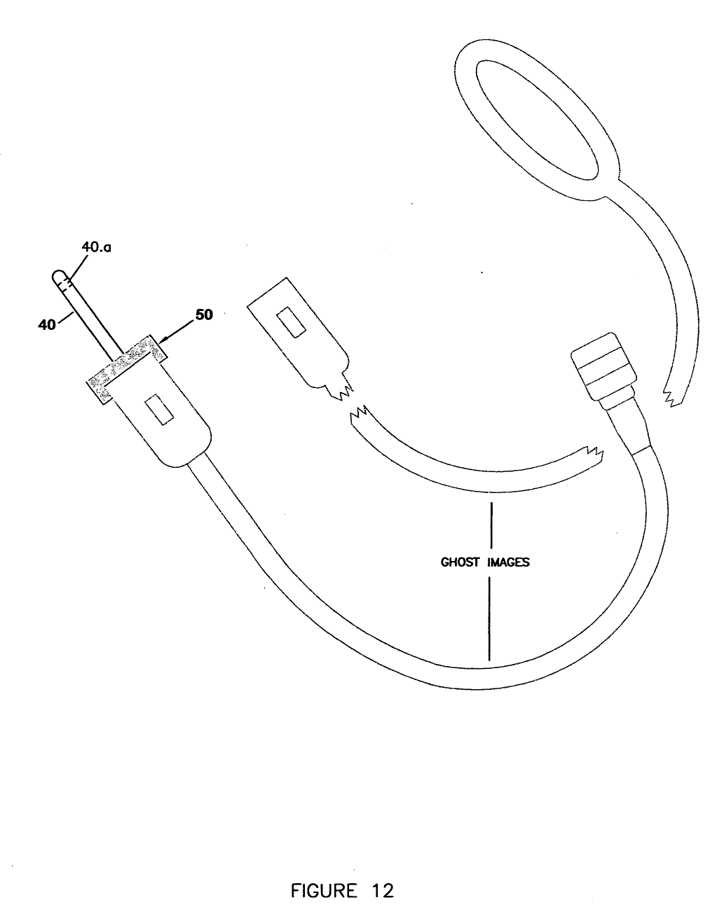

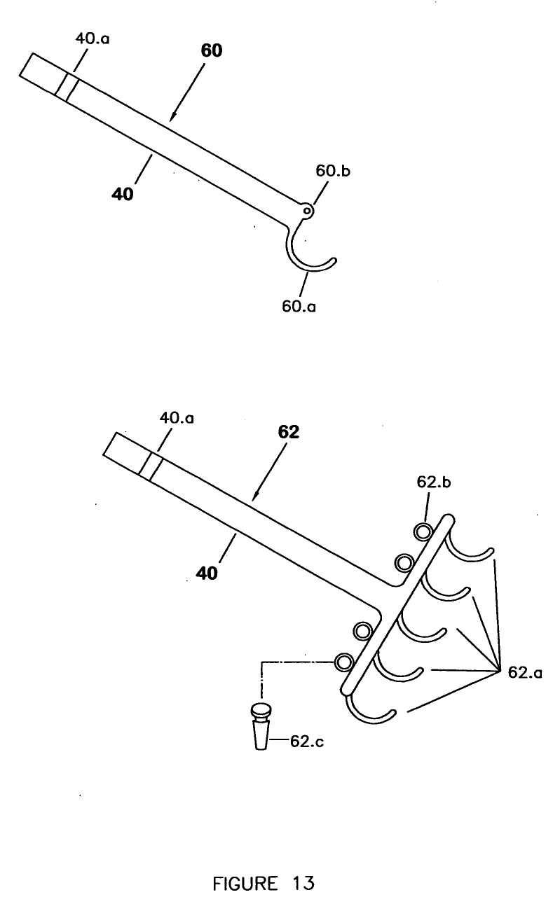

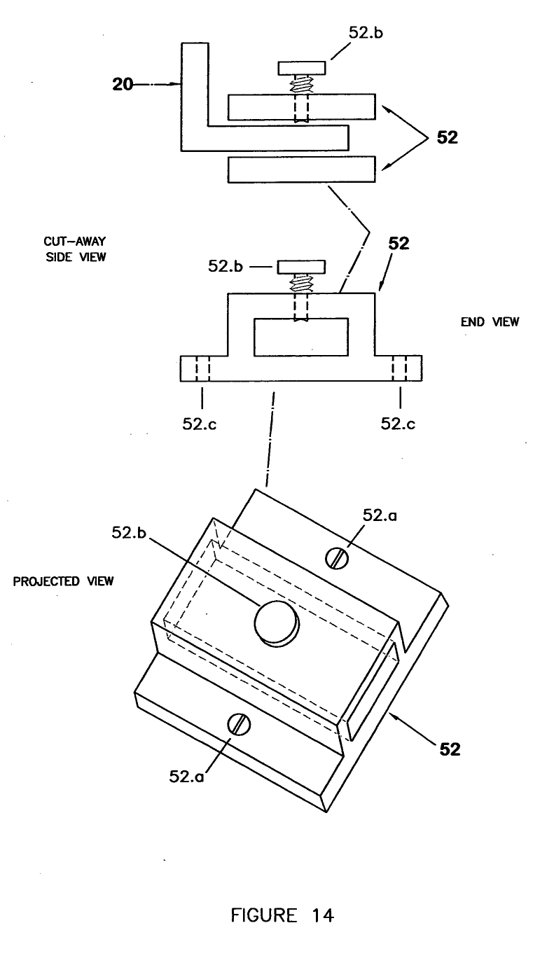

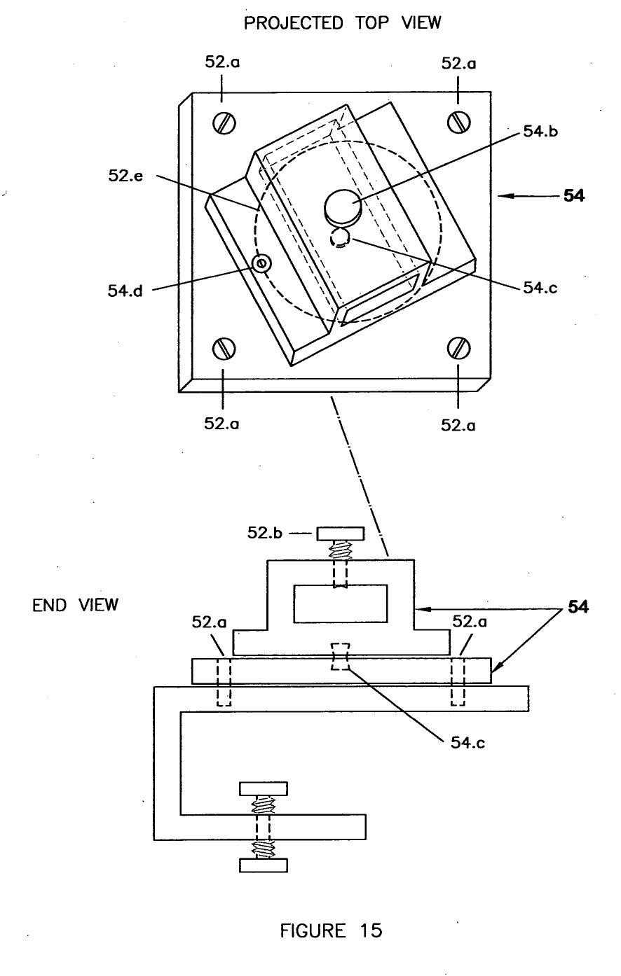

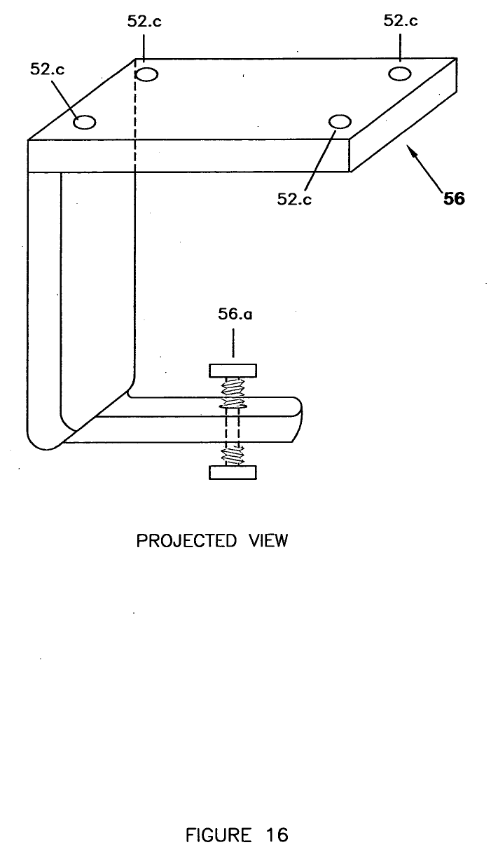

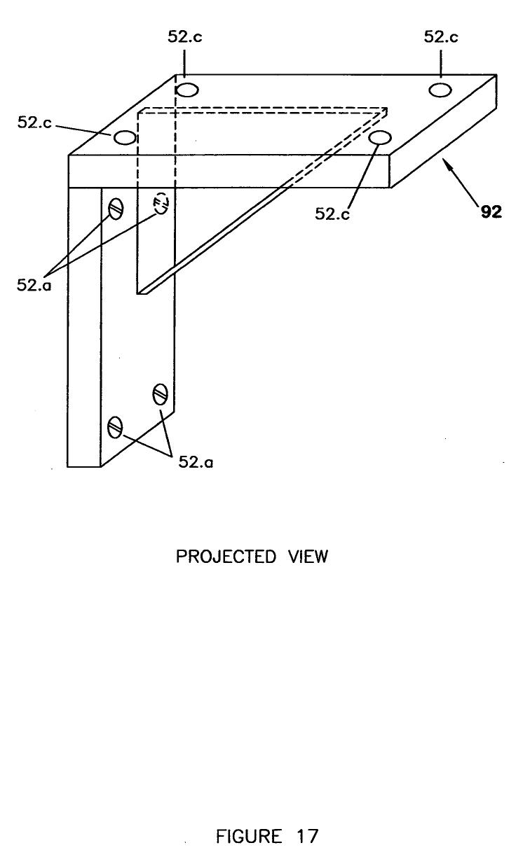

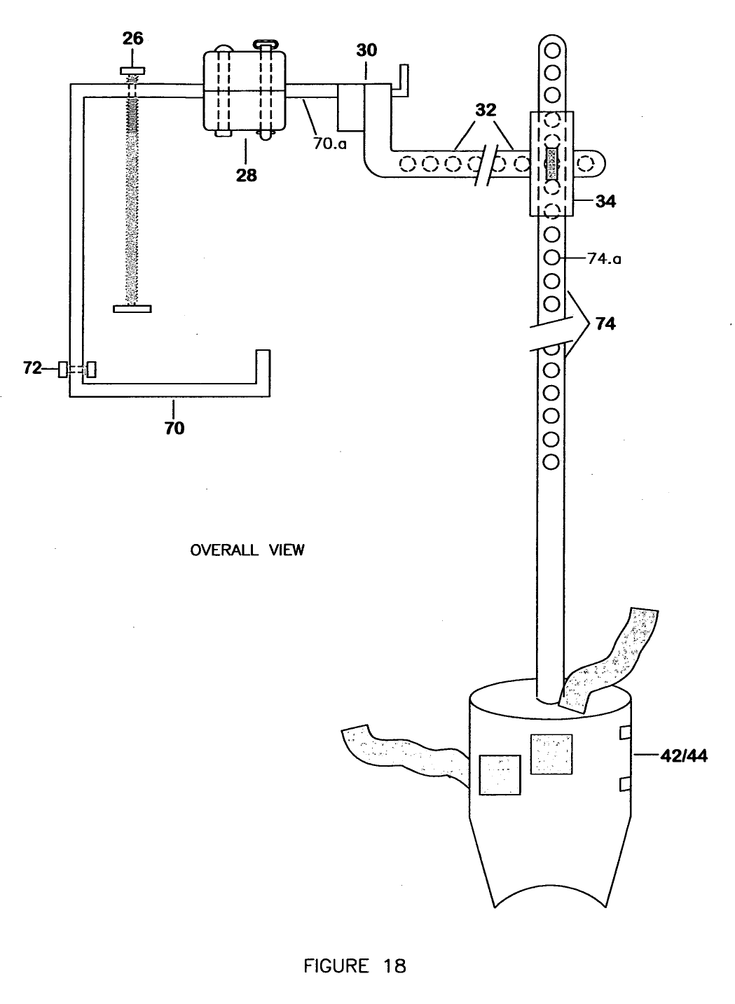

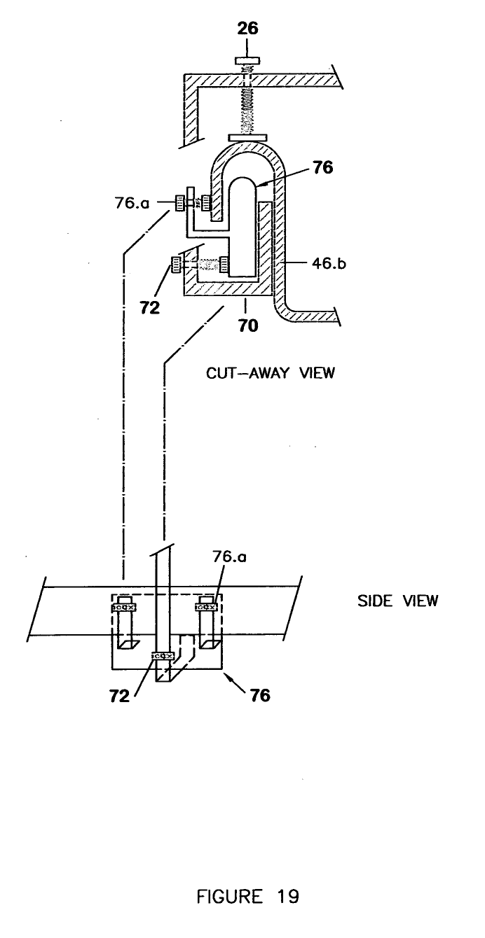

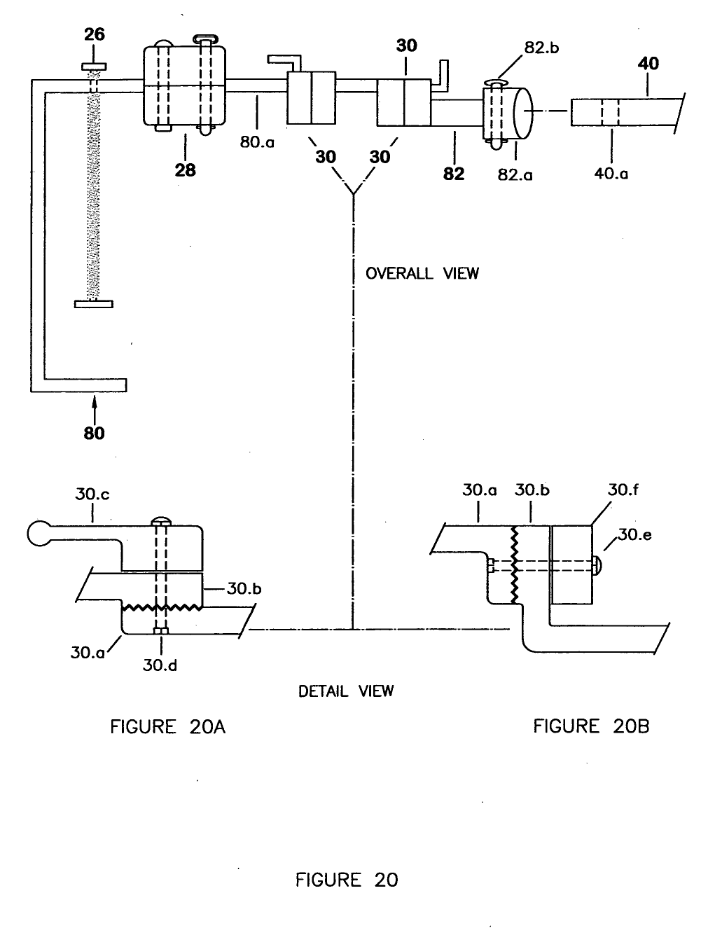

FIG. 7., shows two front views. Right view shows Adjustable Rod 36., integrated with/attached to Attachment Bracket 38., with Quick Release Pin 38.a. Left view shows Adjustable Rod 36., integrated with/attached to Ratchet with Quick Release Safety Knob Handle 30., and Attachment Bracket 38., with Quick Release Pin 38. Below is Quick Attachment Rod 40., permanently attached to Baby Bottle Holder (Clam Shell), 42.

### SERVICEABLE DEVICES, FIGS. 8-17

NOTE: The below listed items are each attached permanently at the factory to a Quick Attachment Rod 40. Each can be used with Universal Holding Device Body FIG. 1., and 20. Universal Holding Device Body, Fixed, FIG. 18., is only suitable for Baby Bottle/Sippie Cup, 42/44., when attached to Adjustable Rod 72.

FIG. 8., shows two projected views. Top right is a projected view of Baby Bottle Holder, Clam Shell, 42. This Funnel Shape/Clam Shell style has two Hinges 42.a., and two pieces of Velcro 42.b. It is integrated with Quick Attachment Rod 40. Lower left is projected view of Baby Bottle Holder, Open Shell, Adjustable, 44. This Open Shell has a Funnel Shape at the bottom, and three pieces of Velcro 42.b. One Velcro strap on left, one on right, and one near Quick Attachment Rod 40. It is integrated with Quick Attachment Rod 40.

FIG. 9., shows a cut away and outside views of Slug 46. It also shows how it is installed/used. Support Bracket, Removable, 22., is removed to install Slug 46., and Slug Tongue 46.a. Cut-away view, shows Slug 46., installed into Holding Device Body, Removable, 20. It is positioned underneath the lip/rounded/rolled over edge of Car Seat/Baby Carrier 46.b. This device can only be used with the Universal Holding Device Body, Adjustable, FIG. 1. Thumb Screw/Hand Knob(s) 24., and 26., secure Slug 46., in position. Outside view shows a different prospective of Slug 46., held in place.

FIG. 10., shows a projected view of Tray (Deep/Shallow) 48., It is integrated part of Quick Attachment Rod, 40.

FIG. 11., shows a projected and exploded views of Computer Table, 58., i.e. for Laptop/Note Book. It has two U-Brackets, 58.c., one for each front corner. It has two L-Brackets, 58.a., one on each side near the rear. It has two other L-Brackets 58.a., in the rear. Each bracket has one or more Thumb Screw/Hand Knob, 58.b. to secure brackets. It is an integral part of Quick Attachment Rod, 40.

FIG. 12., shows a side view of Attachment Base 50., with metal base. It is shown with two ghost images. It is integrated part of Quick Attachment Rod, 40.

FIG. 13., shows two projected views of Hook-Eye Device(s). Single Hook-Eye Device 60., has two sub-parts Hook 60.a., Eye 60.b. Multi Hook-Eye Device 62., also has three sub parts Hook 62.a., Eye 62.b., and Insert Cup 62.c. Each device is an integrated part of Quick Attachment Rod 40.

FIG. 14., shows three views, i.e. cut away, end, and projected views, of Mounting Bracket 52. It is designed to be used with two Devices, i.e. Holding Device Body, Removable, 20., FIG. 1., and Holding Device Body, Change, 80. FIG. 20. It has a place for four Mounting Fasteners 52.a. It has one Thumb Screw/Hand Knob 52.b., on top.

FIG. 15., shows two views, i.e. end and projected views of Rotating Mounting Bracket 54. It is similar in form, fit, and finction as Mounting Bracket 52. It has a place for four Mounting Fasteners 54.a. Rotating Bracket 54., is secured to it's base with Attachment Fixture 54.c. Ball and Spring Plunger/Hand Retractable Spring Plunger/Pull Ring/Spring Plunger(s) 54.d. is the locking device. Holes/Indents/Notches 54.e., are locking receptacles.

FIG. 16. shows a projected view of Temporary Mounting Bracket 56., and Thumb Screw/hand Knob 56.a.

FIG. 17. shows a projected view of Wall Mounting Bracket 92.

### SECOND EMBODIMENT

FIG. 18. is second embodiment. It is an overall view of Universal Holding Device Body, Fixed. This device is similar to FIG. 1., and also has appearance of an open circle. First item to describe is located at lower limb, Holding Device Body, Fixed, 70. It is main supporting structure of device. Moving left, to vertical up-rise, turn upward to Thumb Screw/hank Knob 72. Continue moving upward to top, turn right to Thumb Screw/Hand Knob 26. Proceed right to Hinge 28., i.e. same as Fig.3. Continue right to Ratchet with Quick Release Safety Knob Handle 30., i.e. same as FIG. 4. Continue right to Adjustable Arm 32., i.e. same as FIG. 5. Continue right to Junction Bracket 34., i.e. same as FIG. 6. Here make a right turn onto Adjustable Rod 74. Adjustable Rod 74., must be attached to Baby Bottle/Sippie Cup Holders 42/44., at the factory.

NOTE: Attachment Rod 36., FIG. 1 and Attachment Rod 74., FIG. 16., are interchangeable.

FIG. 19., shows two views, a cut-away and outside. Cut-away view shows Slug 76., installed into Baby Stroller/Car Seat/Baby Carrier 46.b. Slug 76., is very similar to FIG. 9., Slug 46. It is designed to be used only with Universal Holding Device Body, Fixed, FIG. 18. Slug 76 is mounted onto Holding Device Body 70., with Thumb Screw/Hand Knob 72. Slug 76 has Thumb Screw/Hand Knob(s) 76.a., permanently attached.

### THIRD EMBODIMENT

FIG. 20. is third embodiment. It is an overall side view of Universal Holding Device Body, Change. This embodiment is designed slightly different than other two embodiments. This embodiment has a U-Shape appearance. Holding Device Body, Change, 80., is main supporting structure of device. First item of FIG. 20., is located on lower limb, right side. Starting at Holding Device Body, Change, 80., right side of lower limb, move left, turn up vertical stem to top. Turn right on main supporting structure, move right to Thumb Screws/Hand Knobs 26. Moving right on main supporting structure, Holding Device Body, Change, 80., to Hinge 28. Left side of Hinge 28 is integrated with Holding Device Body, Change, 80.a. Right side of Hinge 28 is integrated with Holding Device Body, Movable, 80.a. Move right on Holding Device Body, Movable, 80.a. to Ratchet with or without Quick Release Safety Knob Handle 30. Move right to second Ratchet, 30, i.e. if desired/required by customer. Both Ratchet's have same form fit and fimction as FIG. 4., 30. Move right to Fixed Arm 82., with Attachment Bracket 82.a., and Quick Release Pin 82.b. Lastly is projection lines from Attachment Bracket 82., to Quick Attachment Rod 40.

Below are two exploded side views of Ratchet, i.e. A & B. View “A” has Quick Release Handle and Cam. View “B” has Cap 30.f., installed instead of Quick Release Handle and Cam 30. These detail drawings are same (i.e. form, fit and function) as FIG. 4. & 5.

### OPERATION—FIRST EMBODIMENT

FIG. 1., is first embodiment. It shows an overall view of Universal Holding Device, Adjustable, with detachable item(s). FIG. 1., is viewed from receiving side, i.e. view from sitting in Childs Stroller. Operating side is the side that isn't seen. It is available in different shapes, sizes and material to accommodate customer's requirements. It has three model(s)/weight class, i.e. light, medium, and heavy. Different models make it easy to adapt to either household/hobbyists or commercial/industry needs/requirements. This is done by utilizing some or all of the elements/components/characteristics presented here-in. FIGS. 2., thru 7., are detail drawings/upgrades that expands overall scope of FIG. 1.

Holding Device Body, Removable, 20., is main supporting body. It begins on bottom/lower limb, slightly to right at Support Bracket, Removable, 22. From here move left than up main stem to Thumb Screws/Hand Knobs, Removable, 24. Continue up to top, make right turn to Thumb Screw/Hand Knob 26. Move right to Hinge 28., with Quick Release Pull Pin, that is integrated with/attaches to Holding Device Body, Movable, 20.a. Moving to right is Ratchet with Quick Release Safety Knob Handle 30. Next is Adjustable Arm 32., i.e. with Holes/Indents/Notches. Resting and secured to Adjustable Arm 32., is Junction Bracket 34. Here we make another right turn onto Adjustable Rod 36., i.e. with Holes/Indents/Notches. At far end of Adjustable Rod 36., is Attachment Bracket 38., permanently secured. Projection lines from Attachment Bracket 38., indicate attachment of Quick Attachment Rod 40. Baby Bottle Holder 42., is only one example of numerous Serviceable Devices that can be attached to Quick Attachment Rod, 40.

NOTE: Detail FIGS. 2 thru 7 and Attachments 8 thru 17 expound on operation of all embodiments. They also show versatility of all Universal Holding Device(s).

### DETAIL FIGS.2-7

FIG. 2., is a detail side view of Holding Device Body, Removable, 20. On right side of lower limb is Support Bracket, Removable, 22. Moving left, than up main support is Thumb Screw/Hand Knob, Removable, 24. Moving up to top and turn right is Thumb Screw/Hand Knob 26. At upper right is a projected view of Support Bracket, Removable, 22. Procedure for removing Support Bracket, 22., is very easy. Rotate vertical arm down to meet horizontal part, i.e. Holding Device Body, Removable, 20. Than lifting up on Support Bracket, Removable, 22., and remove. Vertical part of Support Bracket, Removable, 22., has shoulders, thus making horizontal/insert part smaller. Directly below are two exploded views of Thumb Screw/Hand Knob, Removable, 24. To right is a top and bottom views of Thumb Screw/Hand Knob Pressure Plate, Removable, 24.a. Procedure to remove Thumb Screw/Hand Knob 24., from . . . Pressure Plate 24.a., is very easy. Top and Bottom views of Pressure Plate 24.a., are quite different. Top view of Pressure Plate 24.a., shows it's closed. Bottom view of Pressure Plate 24.a., shows it's open. Removal of Pressure Plate 24.a., is accomplished by pulling up on top/closed plate. This procedure will disengage Pressure Plate 24.a., from Thumb Screw/Hand Knob 24. Than unscrew/remove Thumb Screw/Hand Knob 24. Ability to remove these devices transforms it into Universal Holding Device, Adjustable. Following parts make-up a clamping mechanism: Holding Device Body, 20., Support Bracket, Removable, 22., Thumb Screw/Hand Knob, Removable, 24., and Thumb Screw/Hand Knob, 26. It can clamp on side of stroller, or any device that has a open side, etc. You can remove Support Bracket, Removable, 22., and clamp it to any flat surface, e.g. table, bench, machine, or etc. You can also insert Holding Device Body, 20., into either of two Mounting Brackets. Using Mounting Brackets, FIG. 14, FIG. 15, FIG. 16, and FIG. 17 add to it's versatility.

FIG. 3., shows top and side views of Hinge 28. This device is integrated on left side with Holding Device Body, Removable, 20. It is integrated on right side with Holding Device Body, Movable, 20.a. Purpose of Hinge 28., is to open/close easily and quickly, i.e. swing top mechanism, out and way. This can be described as taking it from In-Work position to Out-Work position. Hinge 28., consists of two flat surfaces, each half having one Support(s) 28.e. Hinge 28., i.e. two flat surfaces, are held together with Bolt 28.a., Nut 28.b., Quick Release Pin28.c., and two Support(s) 28.e. Bolt 28.a., and Nut 28.b., are tightened slightly, so there's only a small amount of friction when hinge is operated. Bottom and top parts of Hinge 28., each have two holes at different locations. Two In-Work position Holes 28.d., for inserting Quick Release Pin 28.c. Two Out-Work position Holes 28.d., for inserting Quick Release Pin 28.c. Two unoccupied holes are Out-Work position holes. With Quick Release Pin 28.c., pulled-out, Holding Device Body, Movable, 20.a., can be pushed/pulled to Out-Work Position. Than Quick Release Pin 28.c. can than be installed in Out-Work Position Holes. Loop on Quick Release Pin 28.c., is used to extract Quick Release Pin from Hinge. When Loop is pulled, it releases positive pressure on two spring loaded ball bearings located very close to bottom of pin. Ball bearings recess themselves into pin as pulling pressure is applied, allowing pin to be removed. With pin installed into Hinge 28., spring loaded ball bearings keep pin from falling or vibrating out. Supports 28.e., are there to reduce any excess up/down movement.

FIG. 4., shows five views, i.e. detail side internal, outside, projected, and inside views, of Ratchet with Quick Release Safety Knob Handle 30. Purpose of this device is to adjusts/rotate position of, Adjustable Arm 32., to desired angle. It is integrated with part of, and mounted between Holding Device Body, Movable, 20.a., and Adjustable Arm 32. Side view shows all parts of Ratchet with Quick Release Safety Knob Handle. All pieces, i.e. Ratchet 30a., b., & c., are secured with Bolt 30.d. and Nut 30.e. It doesn't have to be disassembled/removed unless a different size/length Adjustable Arm 32., is required. Top internal and projected views of 30.a., and b., show ratchet teeth. Outside and projected views of 30.b., shows Cam. Inside view of Quick Release Safety Knob Handle 30.c., shows Cam operating mechanism. To operate Ratchet, pull/push Quick Release Handle 30.c., one quarter turn. This will open Ratchet with teeth, 30.a., & b. Adjustable Arm 32., can than rotate approximately 120° up or down from center, i.e. 240° overall. When desired position/angle is achieved, push/pull Quick Release Ratchet Safety Knob Handle 30.c., in the opposite direction. Quick Release Ratchet Handle 30.c. with Safety Knob makes this operation safe and easy.

FIG. 5., shows a different prospective of figure FIG. 4. It shows a detail side view of Adjustable Arm 32., integrated/attached with Inside Teeth/Outside Cam 30.b. Adjustable Arm 32., is available in various replacement sizes/lengths/shapes to accommodate customers needs/requirements. After removing Nut 30e., you can remove Quick Release Safety Knob Handle 30.c. Adjustable Arm 32., maybe remove/replace and reinstall Quick Release Safety Knob Handle 30.c., and Nut 30.e. Purpose of Adjustable Arm 32., is to hold/position Junction Bracket 34. Projection lines from Adjustable Arm 32., to Junction Bracket 34. Adjustable Arm 32., location/position/angle are dictated by customer's needs/requirements. Ratchet with Quick Release Safety Knob Handle 30., will provide the desired angle.

FIG. 6., shows four views, i.e. Junction Bracket 34., Adjustable Arm 32., Adjustable Rod 36., and Safety Cap 90. At top center is a top view of Adjustable Arm 32., holding Junction Bracket 34. At top right is a projected view showing Adjustable Arm 32., holding Junction Bracket 34., and Adjustable Rod 36. At left is a front view of Adjustable Rod 36., attached to Attachment Bracket 38. At lower right is top and projected views of Safety Cap 90., with Knurled Head Slotted Screw 90.a. Top and projected views of Junction Bracket 34., appearances as two tubes. One tube positioned perpendicular on top of other. Each of these two tubes has a Thumb Screw/Hand Knob. Lower tube is designed to ride on Adjustable Arm 32., i.e. with it's many Holes/Indentations/Notches. It can be positioned left or right and secured in place with Thumb Screw/Hand Knob 34.a. This is located on underneath side of Junction Bracket 34. Upper tube is designed to hold/house Attachment Rod 36., i.e. with it's many Holes/Indentations/Notches. It can move in/out and secured by Thumb Screw/Hand Knob 34.b. This is located on upper side of Junction Bracket 34. Ability to move/remove these two items adds to Universal Holding Device's flexibility. Safety Cap 90., may be secured at ends of Adjustable Arm 32., and Adjustable Rod 36., with Thumb Screw/Knurled Head Slotted Screw 90.a. Safety Cap 90., is installed for safety and security purposes.

FIG. 7., shows two front view(s) of Adjustable Rod 36. Left view shows addition of Ratchet with Quick Release Safety Knob Handle 30. This has same form, fit and function as in FIG. 4. Both have Attachment Bracket 38 attached to end. Purpose of Attachment Bracket 38., is to install/attach different types of Serviceable Devices, quickly and easily. Quick Release Pin 38.a. is the same form fit & function as Quick Release Pin 28.c., FIG. 3. Quick Release Pin 38.a., holds Quick Attachment Rod 40., into Attachment Bracket 38. Ratchet with Quick Release Safety Knob Handle 30., allows attached item to be positioned in level/horizontal plane.

### SERVICEABLE DEVICES, FIGS. 8-15.

NOTE: Below Serviceable Devices are each attached permanently at factory to a Quick Attachment Rod 40. Said devices are installed into Attachment Bracket, 38., in the same manner as described in FIG. 7. These items can be used with Universal Holding Device Body, Adjustable, FIG. 1., and Universal Holding Device Body, Change, FIG. 20. Suitable Serviceable Devices must each be attached the factory to Adjustable Rod 74., to be used with Universal Holding Device Body, Fixed, FIG. 18.

FIG. 8., shows two projected views of Baby Bottle Holders. Top right view is Baby Bottle Holder, Clam Shell, 42. This Funnel Shape/Clam Shell style has two Hinges 42.a., on one side. It has two piece of Velcro, 42.b., one on opposite side of hinges to hold it closed. Another piece of Velcro 42.b., at the end to hold baby bottle into funnel shaped end. Lower left view shows a Baby Bottle/Sippie Cup Holder, Open Shell, Adjustable, 44. It is similar in principal as Baby Bottle Holder, Clam Shell, 42., and is permanently attached to Quick Attachment Rod 40. Open Shell style also has a funnel shape at opposite end of Quick Attachment Rod 40. Baby Bottle fits into funnel shape opposite Quick Attachment Rod 40. There's three pieces of Velcro 42.b. One piece is attached on each side, and bitter ends attach to each other. This holds bottle from side to side motion. Third piece of Velcro 42.b., is attached at Quick Attachment Rod 40.end. This bitter end attaches to funnel end to secure Baby Bottle into funnel.

FIG. 9., shows a cut away and outside views of Slug 46., and Slug Tongue 46.a. Slug 46., can only be used/installed in Holding Device Body, Removable, 20.,Ref FIG. 1. It is used with a Car Seat/Baby Carrier that has a rounded/roll over edge. Support Bracket, Removable, 22., is first removed as described in FIG. 2. Slug 46., is than installed into Holding Device Body, Removable, 20.,Ref. FIG. 1. This is done in opposite manner as Support Bracket, Removable, 22., FIG. 2., was removed. First position Tongue 46a., in a semi-horizontal position and insert Tongue 46.a., down into slot on Holding Device Body, Removable, 20. Than rotate Slug 46.a., up into a vertical position. Hold Slug 46., up into a vertical position and install/positioned/inserted up inside lip of Car Seat/Baby Carrier. Than secured in place with Thumb Screw/Hand Knob 24., and 26. Both of these should be tightened simultaneously to insure that Slug 46., is installed/seated properly.

FIG. 10., shows a projected view of Tray (Deep/Shallow) 48. This may be used to hold a multitude of different items (e.g. books for cooking, reading, music; toys; food; etc.).

FIG. 11., shows a projected and two exploded views of Computer Table, Laptop/Note Book, 58. It is designed with two U-Brackets, 58.c., in front corners. Four L-Brackets, 58.a., two on each side near rear, and two in rear. Each bracket is held in place with one or more Thumb Screw/Hand Knob, 58.b. Two Front corner and two side brackets hold Laptop/Note Book down. Two rear brackets keep it pushed into place.

FIG. 12., shows a side view of Attachment Base 50. It has a metal base that is used to attach a magnetic base item (e.g. ghost images of two LED light systems).

FIG. 13., shows two projected views of Hook-Eye Device(s). Single Hook-Eye Device 60., has two sub-parts Hook 60.a., Eye 60.b. Multi Hook-Eye Device 62., has three sub parts, Hook 62.a., and Eye 62.b., and insert Cup 62.c. Single Hook-Eye may be used to hold such things a Mobile to entertain a child, etc. Multi Hook-Eye may be used for holding/attach various items (e.g. Beauty Salon/Barber Shop hair dressing equipment, etc.).

FIG. 14., shows three views, i.e. cut away, end, and projected, of Mounting Bracket 52. It is designed to hold Holding Device Body, Removable, 20., and Holding Device Body, Change, 80. Said device can be attached with multiple types of fasteners. It can accommodate, e.g. wood, sheet metal screws, or machine bolts and nuts. Size and type of fastener must be large and sturdy enough to accommodate weight of attached items. After it is mounted with proper Fasteners 52.a., said devices can be attached. Said devices can slide into opening and tightened with Thumb Screw/Hand Knob 52.b. This device can also be mounted onto a Temporary Mounting Bracket 56., and Wall Mounting Bracket 92., Ref. FIG. 16., and 17., respectfully.

FIG. 15., shows two views, i.e. an end and projected of Rotating Mounting Bracket 54. It is similar in form, fit, and finction as Mounting Bracket 52., plus rotates 360°. Said device can be mounted with multiple types of fasteners. It will accommodate, e.g. wood, metal or sheet metal screws, or machine bolts and nuts. Size and type of fasteners must be large and sturdy enough to accommodate weight of attached items. After it is mounted Holding Device Bodies, 20., and 80., can be installed in the same manner as previously stated for Mounting Bracket 52. This device can also be mounted onto Temporary Mounting Bracket 56., and Wall Mounting Bracket 92., Ref. FIG. 16., and 17., respectfully.

FIG. 16., is Temporary mounting Bracket.

FIG. 17., is Wall Mounting Brackets.

### DESCRIPTION and OPERATION of ALTERNATIVE EMBODIMENTS

FIG. 18., is second embodiment. It shows an overall view of Universal Holding Device, Fixed. FIG. 18., has same basic appears as FIG. 1., but it isn't, some items in FIG. 18., now fixed. This makes it less versatile and less expensive than FIG. 1. How-every, all items have same from, fit, and finction as FIG. 1. It is just less adaptable than FIG. 1. This is the most basic of the three embodiments. It is designed for holding light weight items, e.g. Baby Bottles/Sippie Cup Holder(s) for household/child care use. It is designed to be used on Stroller(s)/Car Seat/Baby Carrier(s). Baby Bottle/Sippie Cup Holder (s) will be factory attached to their own individual Adjustable Rod 74. Holding Device Body, Fixed, 70., is main supporting body. It starts at right side of lower limb, at Up-Right close to center. From here, move left across bottom, turn up to Thumb Screw/Hand Knob, Permanent, 72. Next, move up to top, turn right to Thumb Screw/Hand Knob 26. Move right to Hinge 28., i.e. same form, fit and function as FIG. 3. Move right to Ratchet with Quick Release Safety Knob Handle 30., i.e. same form, fit, function as FIG. 4. Move right to Adjustable Arm 32., with Holes/Indents/Notches, i.e. same form, fit, function as FIG. 5. Move right to Junction Bracket 34, i.e. same form fit and function as FIG. 6. Turn right onto Adjustable Rod 74., i.e. with Holes/Indents/Notches, i.e. same form, fit, function as FIG. 6. Permanently secured at end of Adjustable Rod 74., is Baby Bottle Holder, ref. FIG. 8., ref #42/44.

FIG. 19., is attachment for only second embodiment. It shows a cut away and outside view of Slug 76. It is very similar in form, fit and function as FIG. 9., Slug 46. Slug 76., is designed to be used only with FIG. 18. It is used for attaching FIG. 18., to a Car Seat/Baby Carrier that has a rounded/roll over edge. First install Slug 76 onto the Holding Device Body 70. Than tighten Thumb Screw/Hand Knob 72. Next position Slug 76., under the lip of Car Seat/Baby Carrier. Note: Next three steps should be done simultaneously. Than tighten both Thumb Screws/Hand Knobs 76.a., plus Tighten Thumb Screw/Hand Knob 26. This is done to insure proper installed.

FIG. 20., is third embodiment. It shows one overall view of Universal Holding Device, Change. It also shows two exploded side views of Ratchet with, and without/Quick Release Safety Knob Handle. It has a U-Shape design with one leg longer than other leg. It is available in different shapes, sizes and material to accommodate customer's requirements. Embodiment 3., has three model(s)/weight class (i.e. light, medium, and heavy). Each model is designed for household/hobbyists and commercial/industry to meet customer's requirements. This is done while maintaining some or all of basic elements/components/characteristics presented here-in. Most parts are basically same as FIGS. 1. and 18., i.e. form, fit, and fluction. However Support Bracket 22., Junction Bracket 34., and Adjustable Rod 36, Ref. FIG. 1., are not required here. Starting at lower limb, main support is Holding Device Body, 80. Move left a short distance, turn upwards to top. Make right turn to Thumb Screw/Hand Knob 26., i.e. Ref. FIG. 2. Move right to Hinge 28., i.e. Ref. FIG. 3. Move right to Ratchet(s) with or with/out Quick Release Handle, i.e. Ref. FIG. 4./5. Type, quantity, and directional facing of each device used will be dependent upon customer requirements. Two exploded side views show Ratchet's with/or without Quick Release Safety Knob Handle, and cam, i.e. A, & B. View “A” is said device on a horizontal plane and “B” is vertical. Both views are held together in same manner as FIG. 4., & 5. Customer may elect a Ratchet(s) without Quick Release Safety Knob Handle. A wrench must be used to adjust/change desired angle of Ratchet without Quick Release Safety Knob Handle. Next is Fixed Rod 82., with Attachment Bracket 82.a., and Quick Release Pin 82.b. This unit is available in various lengths to meet the customer's requirements. Next is Quick Attachment Rod 40., with Quick Attachment Rod Hole 40.a. All listed attachments can be used with this embodiment, when attached to Quick Attachment Rod 40. Operation/Function of all these parts is same as first embodiment FIG. 1., and FIG. 2., thru 7. This system has potential to hold many more attachments.

### SPECIFICATIONS:

### Material:

Light Duty: Plastic (e.g. Nylon), Embodiment 1., 2., & 3., FIG., 1.,18., & 20.

Medium duty: Plastic (e.g. Nylon)/Aluminum/Steel, Embodiment, 1 & 3, FIG. 1. & 20.

Heavy Duty: Plastic (e.g. Nylon)/Aluminum/Steel, Embodiment. 1 & 3, FIG. 1 & 20.

Note: All Materials are based upon comparable materials for applicable markets.

Conditions considered are: Safety (Strength/Impact Resistant/Operating) Sanitary (child care/nursing care)

### Dimensions:

Light weight Applications:

Only defined service dimensions are for a light weight Universal Holding Device, embodiment's 1 & 2. It must be able to attach to a Child's Stroller, Side Bar and hold a Baby Bottle Holder and meet these requirements. When attached to Side Bar it must have a:
Width Reach, from outside into center of stroller of: 7″
Height Reach, i.e. distance above: Sufficient to be serviceable, and operate safely
Thickness Reach of: minimum Thickness of Side Bar, i.e. Two Inches (2″)
Depth Reach of: Three & One Half Inches (3½″)
Note: All dimensions are based upon survey by inventor.

Medium and Heavy Applications:

Universal Holding Device, embodiment 1. & 3.
Half Width: *
Tray Thickness: *
Height: *

Similar shape as present embodiments, but may be tailored to meet markets/customer's needs/requirements, while utilizing only the elements presented here-in.

### CONCLUSION, RAMIFICATIONS, and SCOPE

Accordingly reader has seen that there are three embodiments, but only one design presented with three (3) slightly different variations of the Universal Holding Device:

1. Universal Holding Device, FIG. 18., is designed for light weight use, e.g. Baby Bottle/Sippie Cup Holders. These items must be permanently attached to Adjustable Rod, 74., at factory. It is suitable for use with, e.g. Baby Stroller or Car Seat/Carrying Seat.

2. Universal Holding Device, Adjustable, FIG. 1., expands role of FIG. 18. It can have a variety items attached because of several different features. It has two removable parts, i.e. Support Bracket, and Thumb Screw/Hand Knob. Attachment Bracket, with Quick Release Pin has been added. It can be mounted into Mounting Bracket,52., Rotating Mounting Bracket,54., table or work bench. It can also be used with Temporary Mounting Bracket,56., Wall Mounting Bracket, 92. It is designed for household and commercial/industrial, hobbyist use, to hold light, and medium weight items.

3. Universal Holding Device (Change), FIG. 20., further expands the scope of FIG. 1. & 18. It provides still more versatility to meet customers needs. It operates in an entirely different direction and adds more variables. A second Ratchet with or with/out Quick Release Safety Knob Handle can be added/removed. It too can be mounted as stated for FIG. 1. It is designed for commercial/industrial, hobbyist use, to hold light, medium and heavy weight items.

ATTACHMENTS: Baby Bottle/Sippie Cup Holders; Tray for basic items; Computer Tray, for Lap Top/Note Book; Attachment Base for LED Work Light; Hook-Eye Device(s), to hold toys/tools.

NOTE: While above description contains many specifications, these should not be constructed as limitations on the scope of any embodiments, but as exemplifications of the presently preferred embodiments thereof. Many other ramifications and variations are possible within teachings of various embodiments. For example, it has potential and capability of holding specialized devices/equipment for industrial and non-industrial arenas. Scope of this invention should be determined by the appended claims and their legal equivalents, and not by the examples given.

### SERVICEABLE DEVICES:

(a) Slug, for claim 1 only
(b). Baby Bottle Holder, Clam Shell
(c). Baby Bottle/Sippie Cup Holders
(d). Tray
(e). Computer Table, i.e. Lap-Top/Note Book
(f). Attachment Base, with metal base for magnetic work devices
(g). Hook-Eye, i.e. Single & Multiple
(h). Mounting Bracket
(i). Rotary Mounting Bracket
(j) Temporary Mounting Bracket
(k) Wall Mounting Bracket
(l) Slug, for claim 11 only

I claim:

1. A Universal Holding Device, Adjustable. Said claim is a labor saving, task oriented device. It is designed to interface with numerous changeable Serviceable Devices, i.e. (a)-(k) listed at the end of the claims. Said claim has three models/weight classes, i.e. light, medium, and heavy. Said claim is composed of: Holding Device Body, Hinge with Quick Release Pin, Ratchet with/without Quick Release Safety Knob Handle, Adjustable Arm, Junction Bracket, Adjustable Rod.

2. The Holding Device Body of claim 1, is main supporting body, and has two Thumb Screws/Holding Knobs, and one Support Bracket.

3. The one Thumb Screw/Hand Knob and one Support Bracket of claim 2, are removable devices. Removing said devices broadens its serviceability. Said claim can be attached to/used with different mounting brackets/Serviceable Devices. Said claim can be temporally or permanently attached to a variety of different surfaces/items.

4. The Slug Device must be installed into claim 2, prior to attaching said claim to Car Seat/Baby Carrier.

5. The Hinge device with Quick Release Pin device and Support devices of claim 1.
Wherein, the Quick Release Pin device is pulled, provides a means to un-secure, move attached Serviceable Device from its In-Work position to it's Out-Work position.
Wherein, Hinge device has means of being re-secured by installing Quick Release Pin.
Wherein, the Support devices have means to reduce excessive up/down movement of Hinge device.

6. The Ratchet with/without Quick Release Safety Knob Handle of claim 1, wherein the means to change degrees/angle of integrated device, claim 7. i.e. Adjustable Arm/Serviceable Device.

7. The Adjustable Arm device of claim 1, wherein the means to support/hold adjoining device, claim 8.

8. The Junction Bracket device of claim 1, wherein the means of moving left and right on adjoining device, claim 7. Said claim wherein the means of interconnecting both adjoining devices, claim 7., and 9. Said claim wherein the means of securing mechanisms to lock adjoining devices, claim 7., and 9., in desired location/position.

9. The Adjustable Rod device of claim 1 wherein the means of moving said device in and out of adjoining devices.

10. The Attachment Bracket with Quick Release Pin device of claim 9 where-in Quick Release Pin is pulled. This provides a means of allowing said device to facilitate quick and easy removal/replacement of Serviceable Device. After which Quick Release Pin is re-installed.

11. A Universal Holding Device, Fixed. Said claim is designed to hold light weight devices, e.g. Baby Bottles/Sippie Cups/Holders, and used on Strollers/Car Seat/Baby Carrier. Removable devices in claim 1 are fixed devices in said claim. Said claim is comprised of a: Holding Device Body; Hinge with Quick Release Pin; Adjustable Arm; Junction Bracket; Adjustable Rod.

12. The Holding Device Body of claim 1 1, wherein the main supporting body, and has two Thumb Screws/Holding Knobs.

13. The two Thumb Screws/Hand Knobs and Support Bracket of claim 12, are not removable devices. Said devices, enhances its marketability/serviceability, the means to be attached to/used with specific/different items.

14. The Slug device of claim 12 must be installed prior to attaching said claim to Car Seat/Baby Carrier.

15. The Hinge device with Quick Release Pin device and Support devices of claim 1 1.
Wherein, the Quick Release Pin device is pulled, provides a means to un-secure, move attached Serviceable Device from its In-Work position to it's Out-Work position.
Wherein, Hinge device has means of being re-secured by installing Quick Release Pin.
Wherein, the Support devices have means to reduce excessive up/down movement of Hinge device.

16. The Ratchet with/without Quick Release Safety Knob Handle device of claim 1 1, wherein the means to change degrees of angle of integrated device, claim 17., Adjustable Arm/Serviceable Device

17. The Adjustable Arm device of claim 11, wherein the means to support/hold, adjoining device, claim 18.

18. The Junction Bracket device of claim 1 1, wherein the means of moving left and right on adjoining device, claim 17. Said claim wherein the means to interconnect with adjoining devices, claim 17., and 19. Said claim wherein has securing mechanisms to lock adjoining devices, in desired location/position.

19. The Adjustable Rod device of claim 1 1, wherein the means of moving in and out of adjoining device, claim 18.

20. A Universal Holding Device, Change. Said claim is a labor saving, task oriented device. It is designed to interface with numerous Serviceable Devices, i.e. (d)-(g) listed at end of the claims. Said claim has three models/weight classes, i.e. light, medium, and heavy. Said claim is comprised of: Holding Device Body; Hinge with Quick Release Pin; Ratchet with/without Quick Release Safety Knob Handle, and Attachment Bracket.

21. The Holding Device Body of claim 20, is main supporting body, and has one Thumb Screw/Hand Knob.

22. The Thumb Screw/Hand Knob of claim 21, wherein the securing device can be used in conjunction with Serviceable Devices, (d)-(k). Said devices expand its serviceability.

23. The Hinge device with Quick Release Pin device and Support devices of claim 120
Wherein, the Quick Release Pin device is pulled, provides a means to un-secure, move attached Serviceable Device from its In-Work position to it's Out-Work position.
Wherein, Hinge device has means of being re-secured by installing Quick Release Pin.
Wherein, the Support devices have means to reduce excessive up/down movement of Hinge device.

24. The Ratchet with/without Quick Release Safety Knob Handle device of claim 20, wherein the means to change degrees of angle of in use Serviceable Device

25. The Fixed Arm device of claim 20 where-in the means of removing/replacing with different length device(s).

26. The Attachment Bracket with Quick Release Pin device of claim 25, where-in Quick Release Pin is pulled. This provides a means of allowing said device to facilitate quick and easy removal/replacement of Serviceable Device. After which Quick Release Pin is re-installed.
